(19) United States
(12) Patent Application Publication
(10) Pub. No.: US 2006/0241947 A1
(43) Pub. Date: Oct. 26, 2006

(54) Voice prompt generation using downloadable scripts

(76) Inventor: Said O. Belhaj, Orefield, PA (US)

Correspondence Address: RYAN, MASON & LEWIS, LLP, 90 FOREST AVENUE, LOCUST VALLEY, NY, 11560, US

(21) Appl. No.: 11/113,523

(22) Filed: Apr. 25, 2005

(51) Int. Cl. G10L 11/00

(52) U.S. Cl. 704/270.1

(57) ABSTRACT

A device for generating voice prompts comprises a memory, a processor coupled to the memory, and audio playback circuitry coupled to the processor. The processor is configured to retrieve at least one voice prompt file from the memory, and to interpret the file for playback of an associated voice prompt via the audio playback circuitry. The voice prompt file comprises at least one script having a plurality of script subroutines associated therewith, with each script subroutine comprising one or more script instructions. The voice prompt file further comprises a plurality of voice files, with the voice files corresponding to respective words or portions of words for use in voice prompt generation. At least one of the script subroutines of the script invokes one or more of the plurality of voice files.

### FIELD OF THE INVENTION

The present invention relates generally to voice prompts in communication devices or other types of processor-based devices, and more particularly to techniques for generating such voice prompts.

### BACKGROUND OF THE INVENTION

Many different types of communication devices, such as telephone answering machines and facsimile machines, are designed to convey information using voice prompts. For example, answering machines typically use voice prompts to inform users as to the number of messages, the time of receipt of a particular message, and so on. Voice prompts are used to provide similar functionality in a wide variety of other types of communication devices, or more generally processor-based devices, including, for example, computers, personal digital assistants (PDAs), mobile telephones, intelligent appliances, as well as devices associated with voice mail systems, automated call routing systems, interactive voice response (IVR) systems, etc.

The typical conventional approach to providing voice prompt generation in such devices is to build complete voice prompts from voice files that comprise short word “clips,” with each such clip comprising a word or a portion of a word. This approach generally requires that the application software specify the particular word clip sequencing and any inter-clip pauses.

A significant drawback of this conventional approach is that application software developers must expend a great deal of time and effort to achieve a desired level of voice quality from the short word clips. This fine-tuning process often requires repeated trial and error attempts by expert personnel in order to arrive at the final product, leading to increased software development time and higher product cost. Also, because the application software is typically unique to any one set of voice files, any changes to the voice files will require software re-tuning or even different word sequencing in the case of language changes. Such software changes result in further increases in development time and product cost. The need for such changes also limits the ability to provide voice prompt upgrades, and makes it difficult to implement multiple-language prompts that are not defined in advance.

It is therefore apparent that what is needed is an improved approach to voice prompt generation, which frees the application software from its conventional direct dependency on specific voice files and makes it easier to support voice prompt upgrades and multiple-language prompts using a single software release.

### SUMMARY OF THE INVENTION

The present invention in an illustrative embodiment meets the above-noted need by providing a voice prompt file format which allows voice prompt authoring to be separated from application software development.

In accordance with one aspect of the invention, a communication device or other processor-based device comprises a memory, a processor coupled to the memory, and audio playback circuitry coupled to the processor. The processor is configured to retrieve at least one voice prompt file from the memory, and to interpret the file for playback of an associated voice prompt via the audio playback circuitry. The voice prompt file comprises at least one script having a plurality of script subroutines associated therewith, with each script subroutine comprising one or more script instructions. The voice prompt file further comprises a plurality of voice files, with the voice files corresponding to respective words or portions of words for use in voice prompt generation. At least one of the script subroutines of the script invokes one or more of the plurality of voice files.

In the illustrative embodiment, the processor implements a virtual machine for execution of one or more of the scripts of the voice prompt-file, with the virtual machine comprising at least a set of virtual registers, an execution stack, an argument stack, stack pointers, and a program counter. Application software running on the processor invokes a script interpreter which utilizes the virtual machine to execute one or more script instructions defined in at least one of the scripts. The application software passes a voice prompt identifier to the script interpreter in order to initiate playback of the corresponding voice prompt. The script interpreter parses the voice prompt file until a particular set of script instructions corresponding to the voice prompt identifier is located, and then decodes that set of script instructions.

Advantageously, the present invention in the illustrative embodiment allows an application software developer to develop his or her software without any knowledge of the particular voice files that are being used in a given device. Also, a voice prompt author can generate voice prompt files that are usable by different types of application software on different devices. This reduces software development time and product cost, while also providing enhanced flexibility by facilitating product upgrades and multiple-language voice prompts.

### BRIEF DESCRIPTION OF THE DRAWINGS

FIG. 1 is a diagram illustrating voice prompt authoring and execution environments in an embodiment of the invention.

FIG. 2 shows an exemplary voice prompt file in an embodiment of the invention.

FIG. 3 shows an exemplary script that may be incorporated into the FIG. 2 voice prompt file in an embodiment of the invention.

FIG. 4 is a block diagram of a processor-based device, comprising a memory for voice prompt file storage and a processor which implements a script interpreter, in an embodiment of the invention.

### DETAILED DESCRIPTION OF THE INVENTION

The invention will be described herein in conjunction with illustrative embodiments involving use of voice prompt files in communication devices or other processor-based devices. It should be understood, however, that the invention is more generally applicable to any voice prompt application in which it is desirable to provide improved accuracy, efficiency or flexibility in voice prompt generation.

The term “communication device” as used herein is intended to be construed broadly so as to encompass any processor-based device which generates information that is translatable into audible voice prompts.

The term “voice prompt” as used herein is intended to include, for example, an announcement, command, question, or any other audibly perceptible presentation of one or more words or portions of words.

The present invention in an illustrative embodiment uses downloadable scripts defining the manner in which voice prompts are to be generated from voice files in a given device. This advantageously eliminates the requirement of conventional practice that the application software be designed using particular predetermined voice files. Thus, an application software developer can develop his or her software without any knowledge of the particular voice files that are being used in a given device. Also, a voice prompt author can generate voice prompt files that are usable by different types of application software on different devices. This reduces software development time and product cost, while also providing enhanced flexibility by facilitating product upgrades and multiple-language prompts.

FIG. 1 shows a voice prompt authoring environment 100A in which voice prompt files containing scripts may be generated, and a voice prompt execution environment 100B in which application software can process one or more voice prompt files to generate corresponding voice prompts.

The voice prompt authoring process in authoring environment 100A begins with the generation of voice files 102, each comprising a word or a portion of a word, and the arrangement of the voice files into a logical order. In the English language, for example, number words may be ordered as follows:

ZERO, ONE, TWO, THREE, FOUR, FIVE, SIX, SEVEN, EIGHT, NINE, TEN, ELEVEN, TWELVE

OH, THIR, FIF, TEEN, HUNDRED, THOUSAND

This allows for the automation of number enunciation while minimizing storage space.

Next, the voice prompt file author generates a script 104 comprising the announcement rules for the desired voice prompt. This may involve, for example, encoding script instructions explicitly or using a text format similar to that of the C or BASIC programming languages. In the latter case, a suitable compiler tool 106 is needed to compile the text into script instructions. The compiled text is then linked 108 with the processed voice files 102, any address references are resolved, and a file index table is generated. The resulting linked object represents a downloadable voice prompt file 110. This file contains all necessary elements for an application software interpreter to reproduce the voice prompt. The voice prompt file may be verified using a script interpreter 112 similar to that implemented by the application software.

The authoring environment 100A may be implemented on a general-purpose computer system, comprising a processor and an associated memory, using one or more software programs. This system is not explicitly shown in the figure. One skilled in the art would know how to configure and operate such a system.

The authoring process for a given voice prompt may be repeated one or more times, independent of and without reference to any particular application software, until a final version of the voice prompt file is obtained. Once finalized, the resulting voice prompt file is downloaded into execution environment 100B.

The execution environment 100B in this embodiment comprises a processor-based device 120, which may be a consumer product such as an answering machine or other communication device. More specifically, the voice prompt file is downloaded into a memory 122 of the device 120. Memory 122 in this embodiment comprises a FLASH memory, but other types of memory may be used, such as random access memory (RAM), magnetic or optical memory, etc. The device 120 also comprises a processor 124 which runs application software 126. The processor 124 implements a script interpreter which interprets the script in the downloaded voice prompt file to allow generation of the desired voice prompt.

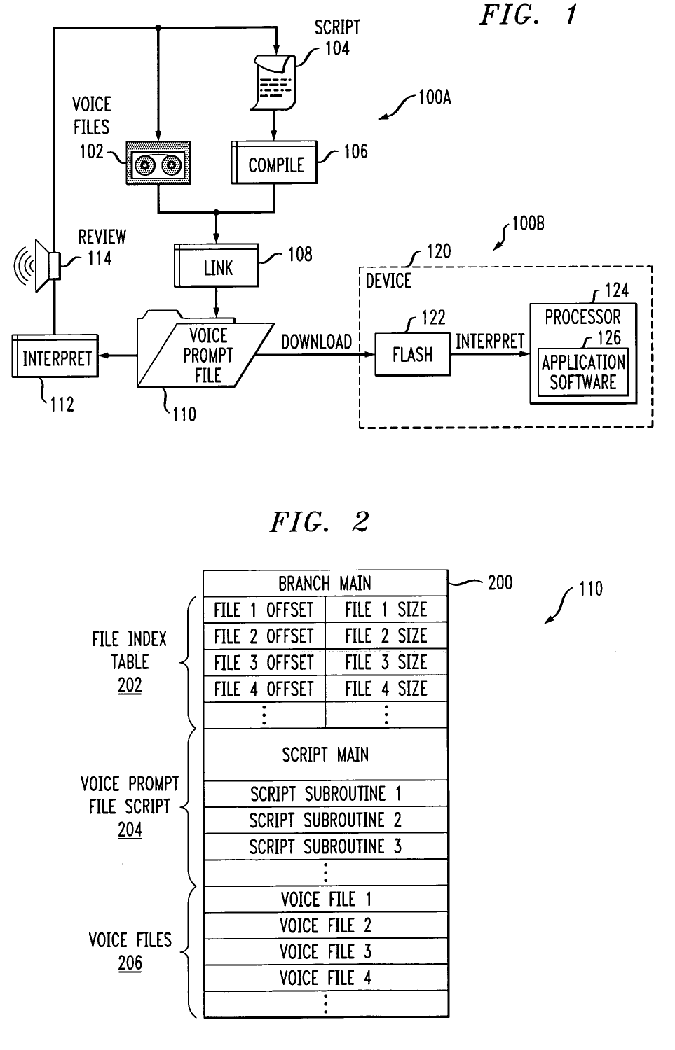

FIG. 2 shows an exemplary format for the voice prompt file 110 generated in the authoring environment 100A of FIG. 1. The voice prompt file 110 comprises a BRANCH main portion 200, a file index table 202, at least one voice prompt file script 204, and voice files 206.

The file index table 202 comprises a plurality of entries, with the entries being associated with respective ones of the voice files 206. More specifically, a given entry of the file index table comprises a file offset and file size for a corresponding one of the voice files.

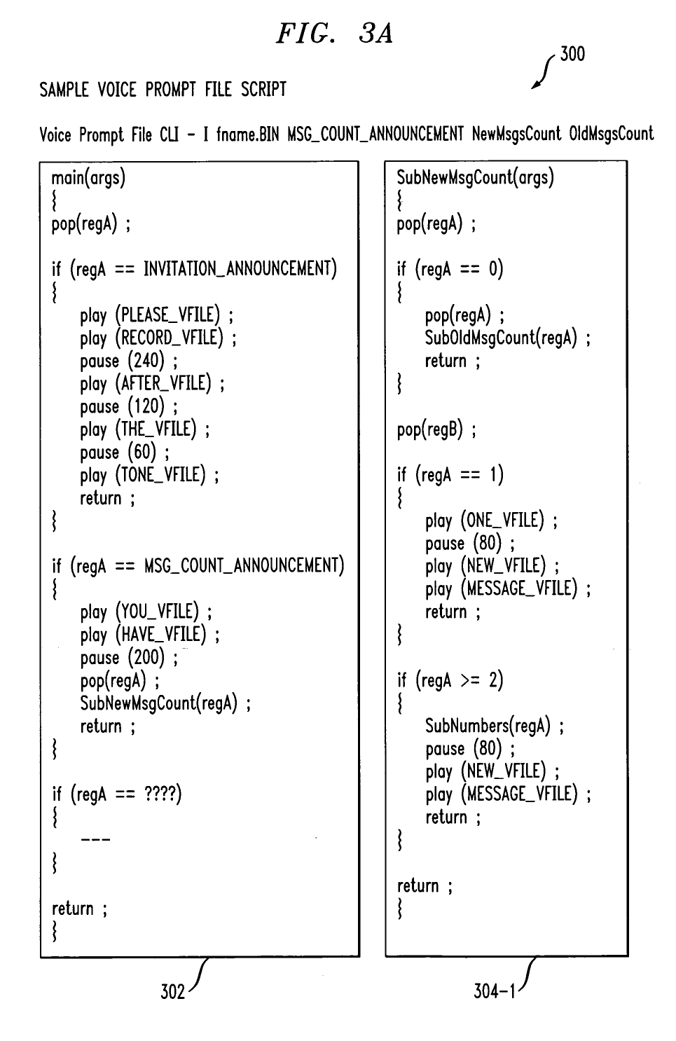

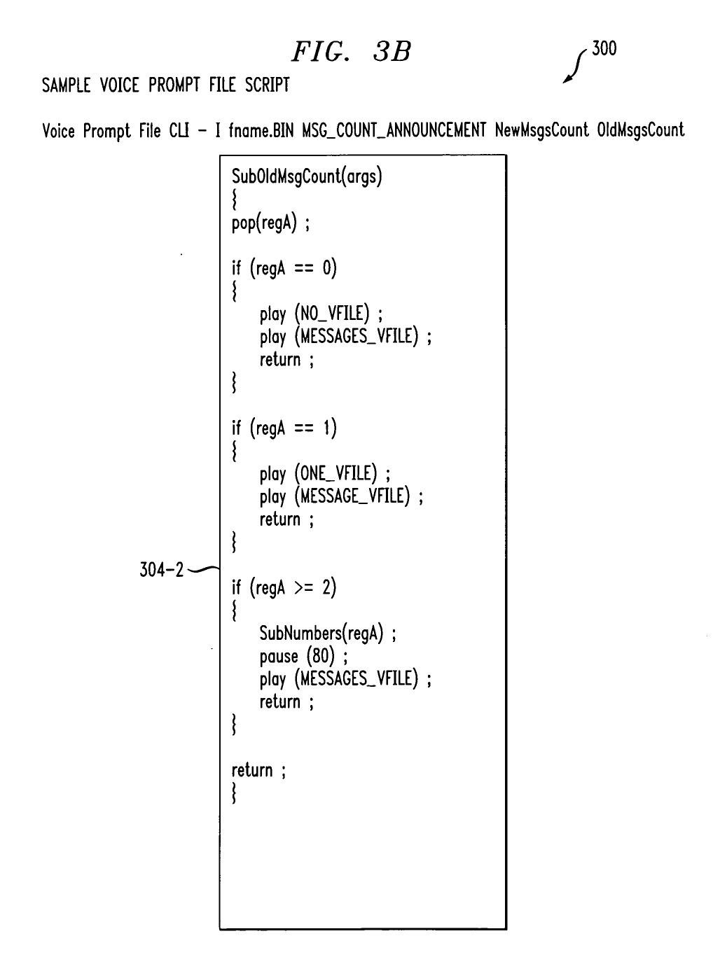

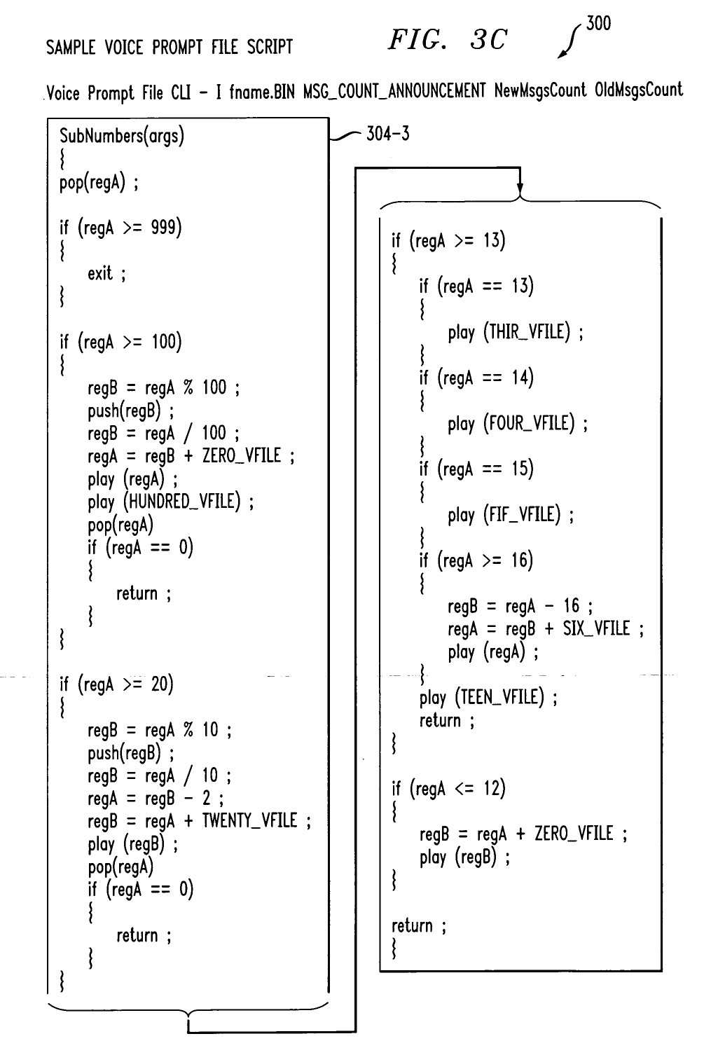

The script 204 comprises a script main portion and a plurality of script subroutines, including Script Subroutine 1, Script Subroutine 2 and Script Subroutine 3. In this embodiment, the script main portion invokes at least one of the script subroutines, and at least one of the script subroutines invokes one or more of the voice files 206, as will be more readily apparent from the example script provided in FIG. 3. Also, one or more of the script subroutines may each invoke other ones of the script subroutines.

The BRANCH main portion 200 at the start of the voice prompt file 110 is an instruction which serves as a pointer to the script main portion of the script 204. Other types of instructions or branching arrangements may be used, as will be appreciated by those skilled in the art.

Each script subroutine comprises one or more script instructions. Such instructions may include, by way of example, argument stack instructions, arithmetic instructions, control instructions, test instructions and file instructions. More detailed examples of these instructions are provided in TABLE 1 below. These particular instructions are also referred to herein as virtual instructions, since they are executed by a virtual machine implemented in processor-based device 120. Such virtual instructions may be viewed as examples of what are more generally referred to herein as script instructions.

The voice files 206, which include voice file 1, voice file 2, voice file 3, voice file 4, and so on, correspond to respective words or portions of words for use in voice prompt generation.

The script language in the illustrative embodiment provides an ability to dynamically alter the voice prompt generation process during runtime, based on application software input parameters. Consider the following two examples, involving application software running on a particular type of processor-based device, namely, an answering machine:

1. The application software wishes to invite a caller to record a message after an invitation tone using the announcement PLEASE RECORD AFTER THE TONE.

The script rules for this voice prompt may look like this:

| | |
|---|---|
| play_vrom_word_file ( PLEASE ) | /* play PLEASE word */ |
| play_vrom_word_file ( RECORD ) | /* play RECORD word */ |
| pause ( 240 ) | /* pause for 240ms */ |
| play_vrom_word_file ( AFTER ) | /* play AFTER word */ |
| pause ( 120 ) | /* pause for 120ms */ |
| play_vrom_word_file ( THE ) | /* play THE word */ |
| pause ( 60 ) | /* pause for 60ms */ |
| play_vrom_word_file ( TONE ) | /* play TONE word */ |

In this example, the script rule “play_vrom_word file (x)” generally denotes an instruction to play a particular voice file corresponding to word or word portion x.

2. The application software wishes to announce the number of messages recorded on the answering machine. In this case, the announcement played to the user is dynamically selected based on the number of messages available in the device at the time of making the announcement. For example:

YOU HAVE NO MESSAGES, if no messages were recorded.

YOU HAVE ONE MESSAGE, if only one message was recorded.

YOU HAVE FOURTEEN MESSAGES, if fourteen messages were recorded.

YOU HAVE ONE NEW MESSAGE, if one unheard message was recorded.

YOU HAVE SIXTEEN NEW MESSAGES, if sixteen unheard messages were recorded.

Clearly, the number of distinct announcements is numerous, determined by a combination of the number of old and new messages recorded on the device. As indicated above, the script language provides runtime decision-making capabilities to allow the application to dynamically select the appropriate rule to make the most suitable announcement.

The script language in this embodiment defines a virtual machine within the main application processor, including a set of virtual registers, a call nesting or execution stack, an argument stack, stack pointers, and a program counter. To resolve the announcement playback rules, the application software runs a script interpreter and executes virtual instructions to determine the correct word sequence.

When the application software wishes to play an announcement, the application software calls the script interpreter and passes it the announcement identifier (e.g., index) as a parameter. The script interpreter traverses through the script instructions until a matching announcement identifier is found in the list of available announcements in the voice prompt file and decodes the rules defined for that announcement. For announcements that require additional runtime information, such as number of messages or message timestamp announcements, the announcement parameters are placed on the arguments stack of the virtual machine and extracted by the interpreter for evaluation whenever a decision making rule is encountered in the script.

The virtual machine instructions in this embodiment include OpCode and OpData fields. The OpCode field determines how the interpreter executes the instruction and the OpData field holds the instruction data/address to be acted upon. An example of a set of script instructions is provided in TABLE 1 below.

TABLE 1
Voice Prompt File Script Instructions

| | |
|---|---|
| Argument Stack Instructions: | |
| PUSH REG | Puts argument on stack |
| PUSH const | |
| POP REG ⁽¹⁾ | Removes argument from stack |
| Arithmetic Instructions: | |
| REGn = REGm + const | Argument offset |
| REGn = REGm − const | |
| REGn = REGm * const | Argument multiplication |
| REGn = REGm/const | Argument integer division |
| REGn = REGm % const | Argument division remainder |
| Control Instructions: | |
| BRANCH add | Branch to script address. |
| CALL add ⁽²⁾ | Saves register context and |
| | program counter to execution |
| | stack, and branches to address. |
| RETURN ⁽¹⁾ | Restores register context and |
| | PC from execution stack. |
| EXIT | Terminates script execution. |
| Test Instructions: | |
| REG == const | Argument test |
| REG != const | Argument exclusion test |
| REG >= const | Argument range test |
| REG <= const | |
| File Instructions: | |
| PLAY REG | Reads specified file. File |
| PLAY const | size and physical address are |
| | obtained from File Index Table |
| REPEAT times | Reads last file specified number |
| | of times. Used to implement |
| | pause periods by playing silence |
| | frame multiple times. |

⁽¹⁾ Control is returned to interpreter if either argument or execution stack is empty.
⁽²⁾ Saving register context may be restricted to a subset of registers.

To implement an inter-word pause, the script language configures one of the voice files to contain a single silence frame. By playing the silence frame multiple times to implement pause periods, valuable voice prompt storage space is maximized to hold voice data.

For example, with a 20 ms frame speech coder, a 240 ms pause period is implemented as follows:

PLAY silence_file_id/* plays 20 ms silence frame*/

REPEAT 11/* repeats playing the silence frame 11 more times (12* 20=240 ms)*/

FIG. 3 shows a detailed example of a voice prompt file script 300 for providing a message count announcement. The script 300 may be viewed as a more particular example of voice prompt file script 204 in the voice prompt file format of FIG. 2. The script 300 includes a script main portion 302 and three script subroutines denoted 304-1, 304-2 and 304-3, respectively. The main portion and the subroutines each implement one or more script instructions. It can be seen that the main portion invokes subroutine 304-1, which in turn invokes subroutines 304-2 and 304-3. Subroutine 304-2 also invokes subroutine 304-3.

In this example, the MSG_COUNT_ANNOUNCEMENT parameters are passed in the order: AnnouncementId, NewMsgsCount, OldMsgsCount.

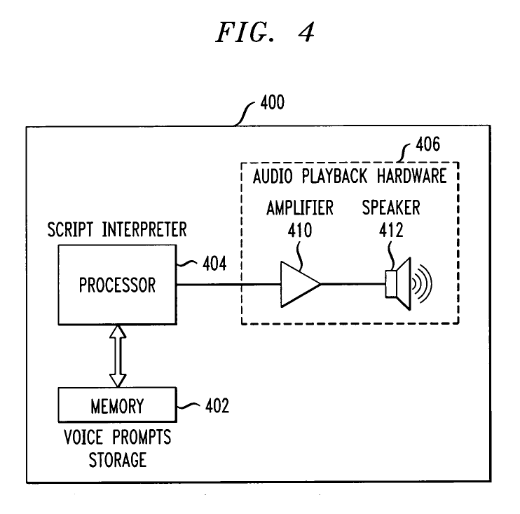

FIG. 4 shows an illustrative embodiment of a processor-based device 400 for generating voice prompts using one or more voice prompt files having the format shown in FIG. 2. The processor-based device 400 may be viewed as being representative of a particular type of consumer product, such as an answering machine, a facsimile machine, a computer, a PDA, a mobile telephone, an intelligent appliance, etc. Such consumer products are considered examples of what are more generally referred to herein as communication devices. It is to be appreciated that the present invention can be implemented in any communication device or other processor-based device in which generation of voice prompts is desirable. Such processor-based devices may comprise, for example, stand-alone devices, or devices associated with voice mail systems, automated call routing systems, IVR systems, or any other kind of system involving generation of voice prompts.

The processor-based device 400 in this embodiment comprises a memory 402, a processor 404 and audio playback hardware 406. The audio playback hardware 406 is an example of what is more generally referred to herein as audio playback circuitry, and in this embodiment comprises an amplifier 410 coupled to a speaker 412. It is to be appreciated that the particular configuration of elements such as audio playback hardware 406 may vary depending upon the particular application in which the processor-based device implemented. For example, in a system in which voice prompts are delivered over a network, the processor-based device may generate the voice prompts in the form of packets that are suitable for delivery over the network, rather than using an amplifier and speaker as in this particular illustrative embodiment. Thus, the term “audio playback circuitry” as used herein is intended to include, for example, circuitry which generates packets or other signals for playback by another device.

In operation, the memory 402 stores one or more voice prompt files having the format shown in FIG. 2. Such files may be downloaded to the memory 402 in a conventional manner, for example, over a network. The processor 400 is configured to retrieve at least one stored voice prompt file from the memory, and to interpret the file for playback of an associated voice prompt via the audio playback hardware 406. The processor 400 implements a script interpretation function for interpreting the scripts of the retrieved voice prompt file. As indicated previously, the playback in this embodiment is via amplifier 410 and speaker 412, although numerous other playback arrangements may be used, including one in which audio playback circuitry generates packets or other information for delivery to and playback on another device.

The present invention in the embodiments described above provides significant advantages relative to conventional voice prompt approaches. For example, application software development time is reduced. Voice prompts can be developed in parallel with application software by personnel with little or no software experience, allowing application software developers to devote their efforts to developing product software. Multiple-language support is provided through downloadable voice prompt files and associated scripts. Also, support for voice prompt upgrades are provided with no impact on application software, thereby allowing for new features such as customer downloadable voice prompts that select different speaker voices, different accents, or even customer voice recordings.

The present invention may be implemented in the form of one or more integrated circuits. For example, memory 402 and processor 404 may comprise a single integrated circuit, or a set of integrated circuits. Numerous other configurations are possible.

In such an integrated circuit implementation, a plurality of identical die are typically formed in a repeated pattern on a surface of a semiconductor wafer. Each die includes a device described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

As noted previously, the present invention may also be implemented at least in part in the form of one or more software programs that, within a given communication device, are stored in a memory and run on a processor. Such processor and memory elements may comprise one or more integrated circuits.

Again, it should be emphasized that the embodiments of the invention as described herein are intended to be illustrative only.

For example, the particular voice prompt files and voice prompt scripts of the illustrative embodiments may be modified to accommodate other voice prompt generation applications, in communication devices or other types of processor-based devices. Also, the particular arrangements of processor, memory and audio playback elements as shown in the figures may be varied in alternative embodiments. These and numerous other alternative embodiments within the scope of the following claims will be readily apparent to those skilled in the art.

What is claimed is:

1. An apparatus for generating voice prompts, the apparatus comprising:
a memory;
a processor coupled to the memory; and
audio playback circuitry coupled to the processor;
the processor being configured to retrieve at least one voice prompt file from the memory, and to interpret the file for playback of an associated voice prompt via the audio playback circuitry;
wherein the voice prompt file comprises (i) at least one script having a plurality of script subroutines associated therewith, each script subroutine comprising one or more script instructions, and (ii) a plurality of voice files, the voice files corresponding to respective words or portions of words for use in voice prompt generation; and
wherein at least one of the script subroutines of the script invokes one or more of the plurality of voice files.

2. The apparatus of claim 1 wherein the voice prompt file further comprises a file index table, the file index table comprising a plurality of entries, the entries being associated with respective ones of the voice files.

3. The apparatus of claim 2 wherein a given entry of the file index table comprises a file offset and file size for a corresponding one of the voice files.

4. The apparatus of claim 1 wherein the script of the voice prompt file comprises a script main portion, the script main portion invoking at least one of the script subroutines.

5. The apparatus of claim 1 wherein at least one of the script subroutines invokes another one of the script subroutines.

6. The apparatus of claim 1 wherein the script instructions of a given one of the script subroutines comprise at least one of an argument stack instruction, an arithmetic instruction, a control instruction, a test instruction and a file instruction.

7. The apparatus of claim 1 wherein the script instructions of a given one of the script subroutines comprise one or more play instructions.

8. The apparatus of claim 1 wherein a given one of the voice files comprises a single silence frame of a predetermined duration.

9. The apparatus of claim 8 wherein the given voice file is invoked multiple times in order to implement a pause period in a voice prompt.

10. The apparatus of claim 1 wherein the voice prompt file implements one or more voice prompts using a particular speaker voice.

11. The apparatus of claim 1 wherein the voice prompt file implements one or more voice prompts using a particular speaker accent.

12. The apparatus of claim 1 wherein the voice prompt file implements one or more voice prompts using a voice of a particular device user derived from one or more voice recordings provided by the user.

13. The apparatus of claim 1 wherein the voice prompt file is generated in a voice prompt authoring environment and downloaded into the memory.

14. The apparatus of claim 1 wherein the processor implements a virtual machine for execution of one or more of the scripts of the voice prompt file, the virtual machine comprising at least a set of virtual registers, an execution stack, an argument stack, stack pointers, and a program counter.

15. The apparatus of claim 14 wherein application software running on the processor invokes a script interpreter which utilizes the virtual machine to execute one or more script instructions in at least one of the scripts.

16. The apparatus of claim 15 wherein the application software passes a voice prompt identifier to the script interpreter in order to initiate playback of the corresponding voice prompt.

17. The apparatus of claim 16 wherein the script interpreter parses the voice prompt file until a particular set of script instructions corresponding to the voice prompt identifier is located, and then decodes the particular set of script instructions.

18. The apparatus of claim 1 wherein the apparatus comprises one or more integrated circuits.

19. An apparatus for generating voice prompts, the apparatus comprising:
a memory; and
a processor coupled to the memory;
the processor being configured to retrieve at least one voice prompt file from the memory, and to interpret the file for playback of an associated voice prompt;
wherein the voice prompt file comprises (i) at least one script having a plurality of script subroutines associated therewith, each script subroutine comprising one or more script instructions, and (ii) a plurality of voice files, the voice files corresponding to respective words or portions of words for use in voice prompt generation; and
wherein at least one of the script subroutines of the script invokes one or more of the plurality of voice files.

20. A voice prompt file format comprising:
at least one script having a plurality of script subroutines associated therewith, each script subroutine comprising one or more script instructions; and
a plurality of voice files, the voice files corresponding to respective words or portions of words for use in voice prompt generation;
wherein at least one of the script subroutines of the script invokes one or more of the plurality of voice files.

21. A method for generating voice prompts utilizing a device comprising a processor coupled to a memory, the method comprising the steps of:
retrieving at least one voice prompt file from the memory; and
interpreting the file for playback of an associated voice prompt;
wherein the voice prompt file comprises (i) at least one script having a plurality of script subroutines associated therewith, each script subroutine comprising one or more script instructions, and (ii) a plurality of voice files, the voice files corresponding to respective words or portions of words for use in voice prompt generation; and
wherein at least one of the script subroutines of the script invokes one or more of the plurality of voice files.
